(19) United States
(12) Patent Application Publication
(10) Pub. No.: US 2026/0319282 A1
(43) Pub. Date: Oct. 15, 2026

(54) Electro-Optically Tunable Localized Guided Mode Resonant Metasurfaces

(71) Applicant: California Institute of Technology, Pasadena, CA (US)

(72) Inventors: Ruzan Sokhoyan, Pasadena, CA (US); Martin Thomaschewski, Pasadena, CA (US); Harry A. Atwater, South Pasadena, CA (US)

(73) Assignee: California Institute of Technology, Pasadena, CA (US)

(21) Appl. No.: 19/646,114

(22) Filed: Apr. 13, 2026

Related U.S. Application Data
(60) Provisional application No. 63/788,350, filed on Apr. 14, 2025.

(51) Int. Cl. G02F 1/035

(52) U.S. Cl. CPC G02F 1/035; G02F 2202/20; G02F 2203/15; G02F 2203/18

(57) ABSTRACT

Systems and methods for high quality factor electro-optically tunable transmissive metasurfaces are described. The metasurfaces comprises a plurality of unit cells arranged in an array. Each of the plurality of unit cells comprises a resonant structure on an electro-optic layer. The resonant structure comprises two protrusions. The resonant structure has a higher refractive index than the electro-optic layer. A ground electrode on the electro-optic layer is adjacent to a side of the resonant structure and a biased electrode is adjacent to an opposite side of the resonant structure. An an electric field can be applied laterally across the electro-optic layer via the electrodes to change a refractive index of the electro-optic layer to modulate an optical response of the metasurface.

### CROSS-REFERENCE TO RELATED APPLICATIONS

The current application claims the benefit of and priority under 35 U.S.C. § 119 (e) to U.S. Provisional Patent Application No. 63/788,350 entitled “Electro-Optically Tunable Guided-Mode-Resonant Metasurfaces” filed Apr. 14, 2025. The disclosure of U.S. Provisional Patent Application No. 63/788,350 is hereby incorporated by reference in its entirety for all purposes.

### STATEMENT OF FEDERAL FUNDING

This invention was made with government support under Grant No. FA9550-21-1-0312 awarded by the Air Force (AFOSR). The government has certain rights in the invention

### FIELD OF THE INVENTION

The present invention generally relates to systems and methods for electro-optically tunable localized guided mode resonant (L-GMR) metasurfaces.

### BACKGROUND

Metasurfaces are ultrathin, planar arrays of subwavelength-scale structures engineered to manipulate light. When combined with electro-optic tuning mechanisms, the metasurfaces become dynamically reconfigurable—allowing real-time control over the phase, amplitude, polarization, or spectrum of light. Metasurfaces encode optical responses through the geometry, size, orientation, and material composition of its constituent resonators. In a tunable metasurface, an applied electric field modifies one or more of these properties, shifting the optical response on demand.

### BRIEF SUMMARY

Many embodiments are directed to systems of high quality factor metasurfaces, which can passively or actively control the wavefront of reflected or transmitted light. The metasurface comprises a plurality of unit cells. The unit cell is a localized guided mode resonant (LGMR) structure. The unit cell can be positioned on a substrate or a layer of a lower-index electro-optic material, whose refractive index can be dynamically controlled upon application of a direct current (DC) electric field across it.

Some embodiments include a metasurface, comprising: a plurality of unit cells; wherein each of the plurality of unit cells comprises: a resonant structure, wherein the resonant structure comprises two protrusions, wherein the two protrusions are configured to couple light from free space into the resonant structure such that an excitation of a resonant mode occurs inside the resonant structure; an electro-optic layer, wherein the resonant structure is on the electro-optic layer, wherein the resonant structure has a higher refractive index than the electro-optic layer; a first electrode connected to a ground, wherein the first electrode is adjacent to a first side of the resonant structure, wherein the first electrode is on the electro-optic layer; and a second electrode connected to a voltage, wherein the second electrode is adjacent to a second side of the resonant structure, wherein the second side is on an opposite side of the first side, wherein the second electrode is on the electro-optic layer; wherein the first electrode and the second electrode are configured to apply an electric field laterally across the electro-optic layer to change a refractive index of the electro-optic layer to modulate an optical response of the metasurface.

Some embodiments further comprise a substrate, wherein the electro-optic layer is on the substrate.

In some embodiments, the plurality of unit cells is arranged in an array.

In some embodiments, the resonant structure has a higher refractive index than the substrate.

In some embodiments, the electro-optic layer has a different refractive index than the substrate.

In some embodiments, the resonant structure comprises a material selected from the group consisting of: silicon, amorphous silicon, germanium, gallium arsenide, gallium phosphide, titanium oxide, and molybdenum disulfide.

In some embodiments, the electro-optic layer comprises a material selected from the group consisting of: barium titanate, lithium niobate, lead zirconate titanate, and JRD1.

In some embodiments, the first electrode and the second electrode each comprises a material selected from the group consisting of: gold, silver, copper, palladium, platinum, indium tin oxide, cadmium oxide, gallium arsenide, indium arsenide, and molybdenum disulfide.

In some embodiments, the resonant structure is symmetrical and each of the two protrusions protrudes from the first side and the second side respectively.

In some embodiments, the resonant structure is asymmetrical and each of the two protrusions protrudes from the first side and the second side respectively.

In some embodiments, the resonant structure is symmetrical and the two protrusions protrude from a top surface of the resonant structure.

Some embodiments further comprise a Bragg grating, wherein the Bragg grating is on top of the two protrusions.

Some embodiments further comprise a back reflector on an opposite side of the electro-optic layer from the resonant structure.

In some embodiments, a repeating unit comprises two unit cells, wherein a first unit cell has a periodicity in y-direction different from the periodicity in y-direction of a second unit cell.

In some embodiments, the difference of periodicity in y-direction is less than 500 picometers.

Some embodiments further comprise a third electrode, wherein the third electrode is positioned between the resonant structure and the electro-optic layer.

In some embodiments, the electro-optic layer comprises lithium niobate, wherein the first electrode and the second electrode are aligned perpendicular to an optical axis of lithium niobate to maximize an overlap with a Pockels coefficient.

In some embodiments, the electric field direction alternates beneath adjacent resonant structures such that opposite resonance shifts occur between adjacent resonant structures.

In some embodiments, the resonant structure comprises silicon and the electro-optic layer comprises lithium niobate.

In some embodiments, the metasurface is configured to be a portion of: a wavefront shaping system, a dynamic beam steering system or a chip scale laser.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention. It should be noted that the patent or application file contains at least one drawing executed in color. Copies of this patent or patent application publication with color drawing(s) will be provided by the Office upon request and payment of the necessary fee.

FIG. 1A illustrates a schematic of a metasurface unit cell in accordance with an embodiment.

FIG. 1B illustrates a schematic of a metasurface unit cell in accordance with an embodiment.

FIG. 1C illustrates a schematic of a metasurface unit cell in accordance with an embodiment.

FIG. 1D illustrates a schematic of a metasurface unit cell in accordance with an embodiment.

FIG. 1E illustrates a schematic of a metasurface unit cell in accordance with an embodiment.

FIG. 1F illustrates a schematic of a metasurface unit cell in accordance with an embodiment.

FIG. 1G illustrates a schematic of a metasurface unit cell in accordance with an embodiment.

FIG. 1H illustrates a schematic of a metasurface unit cell in accordance with an embodiment.

FIG. 2A illustrates a schematic of a silicon lithium niobate transmissive metasurface in accordance with an embodiment.

FIG. 2B illustrates a top view of a unit cell of the silicon lithium niobate transmissive metasurface in accordance with an embodiment.

FIG. 2C illustrates a simulated optical field Eₒₚₜ profile of the guided mode confined in a single perturbed waveguide in accordance with an embodiment.

FIG. 2D illustrates a simulated electrostatic field under applied voltage in accordance with an embodiment.

FIG. 2E illustrates a resulting refractive index modulation Δnₓ in the lithium niobate induced by the applied voltage via the Pockels effect in accordance with an embodiment.

FIG. 2F illustrates a tilted-view scanning electron microscope image of the fabricated GMR metasurface in accordance with an embodiment.

FIG. 2G illustrates an SEM image of two adjacent GMR resonator elements with a single driving electrode positioned between them in accordance with an embodiment.

FIG. 2H illustrates guided-mode resonance in the transmission spectrum at 0 V and under applied bias of ±30 V in accordance with an embodiment.

FIG. 2I illustrates phase response extracted from simulations at 0 V and under applied bias ±30 V in accordance with an embodiment.

FIG. 3A through FIG. 3C illustrate symmetric guided-mode-resonance metasurface enabling electro-optic beam splitting via dynamic diffraction in accordance embodiments.

FIG. 4A through FIG. 4H illustrate detuned GMR metasurface for efficient transmission modulation in accordance with embodiments.

FIG. 5A and FIG. 5B illustrate effect of electrode offset on resonance linewidth and quality factor in accordance with embodiments.

FIG. 6 illustrates experimental transmission spectra of guided-mode resonances for different protrusion periods in accordance with an embodiment.

FIG. 7A through FIG. 7C illustrate sensitivity of the GMR spectral position to variations in silicon optical constants and waveguide geometry in accordance with embodiments.

FIG. 8A and FIG. 8B illustrate simulated transmission amplitude and phase response of the calibrated silicon GMR structure in accordance with embodiments.

FIG. 9 illustrates calculated modulation enhancement of a detuned GMR metasurface at a driving voltage as a function of the static detuning parameter Δp_{y} in accordance with an embodiment.

### DETAILED DESCRIPTION

Many embodiments provide dielectric high quality factor (Q or Q factor) metasurface structures in transmission mode and/or in reflection mode. The high Q metasurfaces can control the wavefront of light passively or actively. Several embodiments use high Q subwavelength resonators on top of electro-optic materials as metasurface building blocks such that the metasurface can achieve dynamically tunable optical response upon modulation of the external stimulus. The metasurfaces can be used for (but not limited to) reconfigurable beam steering devices, dynamic holograms, tunable ultrathin lenses, nano-scale devices, nanoscale spatial light modulators, and/or free space optical communications. Many embodiments implement localized guided mode resonant (LGMR) structures in the metasurfaces to achieve electric-optic tuning. Some embodiments integrate the metasurfaces with chip-scale lasers and/or light sources.

In many embodiments, the metasurface comprises a plurality of unit cells. A unit cell (also referred to as a resonator) is the smallest repeating building block of the metasurface. The unit cell can be repeated identically many times in one, two, or three dimensions to form the metasurface. The unit cell of the metasurface can include the resonator plus the surrounding space that gets repeated. In certain embodiments, the unit cell can include the resonator, the substrate underneath the resonator, and/or the gap region between neighboring resonators.

In many embodiments, the metasurface unit cell comprises a high-refractive index LGMR structure and a lower-refractive index electro-optic material layer integrated with the L-GMR structure. The LGMR structure supports high-Q modes. The supported optical mode partially penetrates into the lower-index electro-optic material. Tunable optical response of the metasurface can be achieved by applying DC bias across the electro-optic material. Examples of a high-refractive index material include (but are not limited to) silicon (Si), germanium (Ge), gallium arsenide (GaAs), gallium phosphide (GaP), molybdenum disulfide (MoS₂), and titanium oxide (TiO₂). As can readily be appreciated, any variety of high-refractive index materials can be utilized as appropriate to the requirements of specific applications in accordance with various embodiments of the invention. Examples of the electro-optic material include (but are not limited to) lithium niobate (LNO), barium titanate (BTO), lead zirconate titanate (PZT), and an organic electro-optic polymer such as JRD1 molecules in the PMMA host. As can readily be appreciated, any low-refractive index materials can be utilized as appropriate to the requirements of specific applications in accordance with various embodiments of the invention. The metasurface can work in reflection or transmission mode. The incoming plane wave can be x- or y-polarized.

In some embodiments, the LGMR structure can be on a substrate. The substrate can comprise a lower-refractive index electro-optic material. In some embodiments, the LGMR structure can be on a layer of a lower-refractive index electro-optic material. The refractive index of the electro-optic material can be dynamically controlled by applying a DC electric field across it. In several embodiments, the metasurface unit cell can include a grating placed on top of the LGMR structure. The grating can be made from the same material as the LGMR or a different material.

In several embodiments, the LGMR structures can have different geometries. The LGMR structures can be symmetrical or asymmetrical. In some embodiments, the LGMR structures can have symmetrical protrusions. The symmetrical protrusions can be on the sides of the LGMR structures or on the top surface of the LGMR structures. In some embodiments, the LGMR structures can have asymmetrical side protrusions. The asymmetrical protrusions can be on the sides of the LGMR structures or on the top surface of the LGMR structures. The asymmetry can be introduced by shifting the side protrusions or the top protrusions with respect to each other. When the grating is introduced on top of the structure, the asymmetry can be introduced by shifting the truncated grating ridges with respect to each other. In some embodiments, the LGMR structures can have protrusions on one side of the LGMR structures, such as (but not limited to) left side, or right side, or top side. Such LGMR structures can be symmetrical or asymmetrical. In several embodiments, the asymmetric LGMR structures can be used for passive or dynamic polarization conversion. In other words, the polarization state of the reflected or transmitted light can be dynamically controlled by applying voltage. For example, incoming linearly polarized light can be dynamically converted to linear cross-polarized or elliptically polarized light.

Many embodiments implement different electrical interconnect architectures to dynamically control the optical response of the metasurface. In some embodiments, the electric field is applied laterally, such as, in the x-direction. In such embodiments, electrically conductive electrodes can be included for each unit cell of the metasurface. In some other embodiments, a three-electrode configuration can be implemented for each unit cell of the metasurface. In such embodiments, the side electrodes are grounded, and the voltage can be applied between the central and grounded electrodes. The electrodes can be made of electrically conductive metals such as (but not limited to) gold (Au), silver (Ag), copper (Cu), palladium (Pd), and platinum (Pt). The electrodes can be made of electrically conductive and lightly doped semiconductors such as (but not limited to) indium tin oxide (ITO), cadmium oxide (CdO), silicon (Si), gallium arsenide (GaAs), indium arsenide (InAs), and molybdenum disulfide (MoS₂). As can readily be appreciated, any variety of electrically conductive materials can be utilized as appropriate to the requirements of specific applications in accordance with various embodiments of the invention.

As can be readily appreciated, the metasurfaces in accordance with many embodiments can operate in the transmission mode or the reflection mode. The metasurfaces operating in the transmission mode can also operate in the reflection mode. Some embodiments may convert the metasurfaces in transmission mode to reflection mode by incorporating a metallic and/or dielectric mirror. The metallic and/or dielectric mirror can be positioned underneath the low-refractive index substrate. The metallic and/or dielectric mirror may not be necessary for operating in the reflection mode. Incorporating the metallic and/or dielectric mirror can boost the optical efficiency of the metasurfaces.

In various embodiments, the metasurfaces can achieve quality factor of at least about 10; or at least about 20; or at least about 30; or at least about 40; or at least about 50; or at least about 60; or at least about 70; or at least about 80; or at least about 90; or at least about 100; or at least about 200; or at least about 300; or at least about 400; or at least about 500; or at least about 600; or at least about 700; or at least about 800; or at least about 900; or at least about 1000; or at least about 2000; or at least about 3000; or at least about 4000; or at least about 5000; or at least about 6000; or at least about 7000; or at least about 8000; or at least about 9000; or less than or equal to about 10000; or from about 100 to about 999; or from about 1000 to about 10000; or from about 1000 to about 9999; or from about 3000 to about 9800. In various embodiments, lower-Q or low-Q refers to quality factor from about 100 to about 999. In certain embodiments, higher-Q or high-Q refers to quality factor from about 1000 to about 10000. In certain embodiments, the quality factor can be greater than 10000.

The metasurfaces in accordance with many embodiments can manipulate the wavefront of light of various wavelengths with high quality factors. The light can have wavelengths including (but not limited to) ultraviolet wavelengths from about 100 nm to about 400 nm; visible wavelengths from about 380 nm to about 800 nm; near infrared wavelengths from about 800 nm to about 2500 nm; infrared wavelengths from about 780 nm to about 1000 μm. The light being manipulated by the metasurfaces can have a single wavelength or a range of wavelengths such as broadband illumination. In order to manipulate different wavelengths of incoming light, the metasurfaces can be made of various shapes, and/or various materials. In certain embodiments, the desired dimensions and/or materials of the nanostructures on the substrates can be selected for the light wavelength(s). The metasurfaces can be designed to exhibit multiple high quality optical resonances that appear at different wavelengths and show selective wavefront manipulation capabilities at different wavelengths.

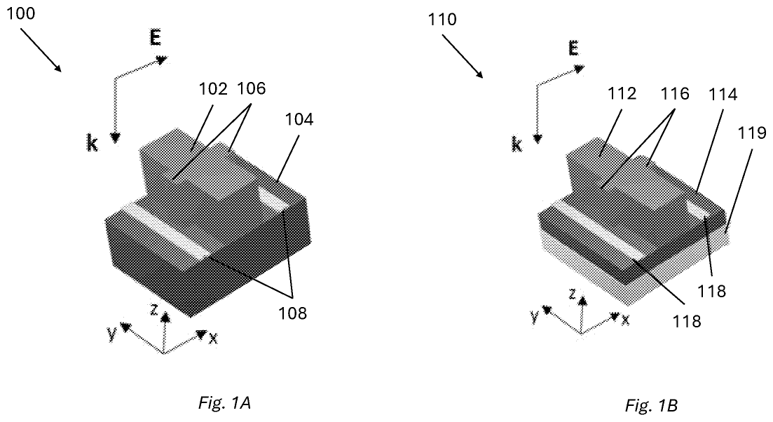

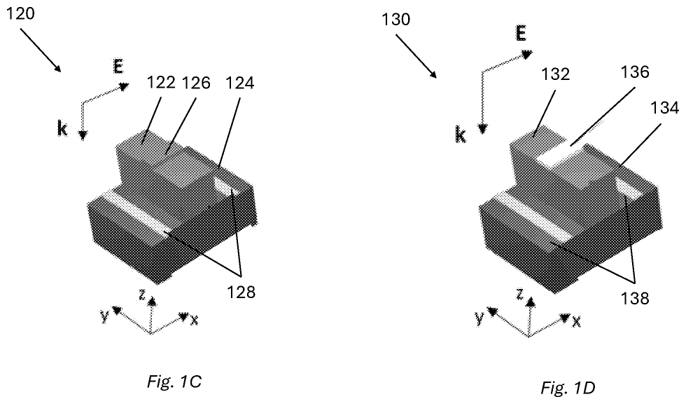

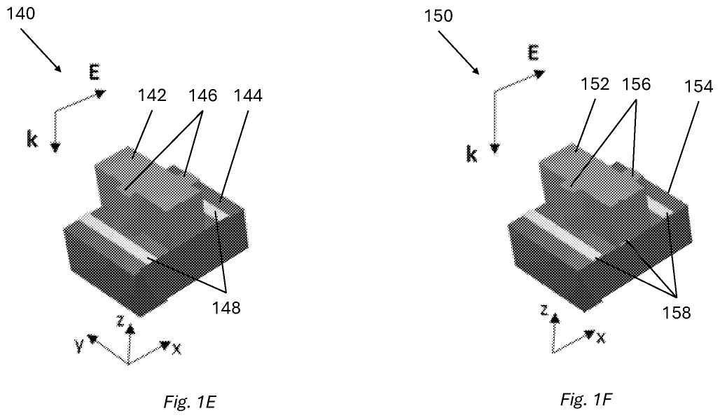

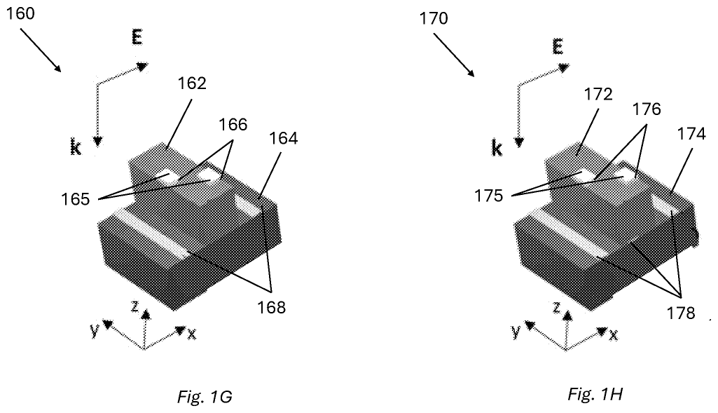

FIG. 1A illustrates a schematic of a metasurface unit cell. The metasurface can be formed by periodically repeating the metasurface unit cells. The unit cell 100 comprises a high-refractive index LGMR structure 102 on a low-refractive index electro-optic substrate 104. The LGMR structure 102 comprises symmetrical side protrusions 106. The unit cell comprises two electrically conductive electrodes 108. Each of the two electrodes 108 is positioned on a side of the LGMR structure 102 such that a DC electric field can be applied in the x-direction to modulate the refractive index of the electro-optic substrate 104.

FIG. 1B illustrates a schematic of a metasurface unit cell. The metasurface can be formed by periodically repeating the metasurface unit cells. The unit cell 110 comprises a high-refractive index LGMR structure 112 on a low-refractive index electro-optic layer 114 on a substrate 119. The low-refractive index layer 114 is thinner than the substrate 119. The substrate 119 can be made of a low-refractive index material that is different from the low-refractive index layer 114. The LGMR structure 112 comprises symmetrical side protrusions 116. The unit cell comprises two electrically conductive electrodes 118. Each of the two electrodes 118 is positioned on a side of the LGMR structure 112 such that a DC electric field can be applied in the x-direction to modulate the refractive index of the electro-optic layer 114.

FIG. 1C illustrates a schematic of a metasurface unit cell. The metasurface can be formed by periodically repeating the metasurface unit cells. The unit cell 120 comprises a high-refractive index LGMR structure 122 on a low-refractive index electro-optic substrate 124. The LGMR structure 122 is a symmetrical structure. A Bragg grating 126 can be on top of the LGMR structure 122. The Bragg grating 126 can be made of the same high-refractive index material as the LGMR structure 122. The unit cell comprises two electrically conductive electrodes 128. Each of the two electrodes 128 is positioned on a side of the LGMR structure 122 such that a DC electric field can be applied in the x-direction to modulate the refractive index of the electro-optic substrate 124. Although the LGMR structure 122 is on an electro-optic substrate 124 as shown in FIG. 1C, the LGMR structure 122 can also be placed on a thin electro-optic layer 114 on a low-refractive index substrate 119.

FIG. 1D illustrates a schematic of a metasurface unit cell. The metasurface can be formed by periodically repeating the metasurface unit cells. The unit cell 130 comprises a high-refractive index LGMR structure 132 on a low-refractive index electro-optic substrate 134. The LGMR structure 132 is a symmetrical structure. A Bragg grating 136 can be on top of the LGMR structure 132. The Bragg grating 136 can be made of a different high-refractive index material as the LGMR structure 132. The unit cell comprises two electrically conductive electrodes 138. Each of the two electrodes 138 is positioned on a side of the LGMR structure 132 such that a DC electric field can be applied in the x-direction to modulate the refractive index of the electro-optic substrate 134. Although the LGMR structure 132 is on an electro-optic substrate 134 as shown in FIG. 1D, the LGMR structure 132 can also be placed on a thin electro-optic layer 114 on a low-refractive index substrate 119.

FIG. 1E illustrates a schematic of a metasurface unit cell. The metasurface can be formed by periodically repeating the metasurface unit cells. The unit cell 140 comprises a high-refractive index LGMR structure 142 on a low-refractive index electro-optic substrate 144. The LGMR structure 142 comprises asymmetrical side protrusions 146. The unit cell comprises two electrically conductive electrodes 148. Each of the two electrodes 148 is positioned on a side of the LGMR structure 142 such that a DC electric field can be applied in the x-direction to modulate the refractive index of the electro-optic substrate 144. The two electrodes 148 are biased with respect to each other. Although the LGMR structure 142 is on an electro-optic substrate 144 as shown in FIG. 1E, the LGMR structure 142 can also be placed on a thin electro-optic layer 114 on a low-refractive index substrate 119.

FIG. 1F illustrates a schematic of a metasurface unit cell. The metasurface can be formed by periodically repeating the metasurface unit cells. The unit cell 150 comprises a high-refractive index LGMR structure 152 on a low-refractive index electro-optic substrate 154. The LGMR structure 152 comprises asymmetrical side protrusions 156. The unit cell comprises three electrically conductive electrodes 158. A first and a second of the three electrodes 158 are positioned on each side of the LGMR structure 152, and the first and second electrodes are grounded. A third electrode 158 is positioned between the LGMR structure 152 and the electro-optic substrate 154. A DC electric field can be applied between the grounded electrodes and the third electrode. Although the LGMR structure 152 is on an electro-optic substrate 154 as shown in FIG. 1F, the LGMR structure 152 can also be placed on a thin electro-optic layer 114 on a low-refractive index substrate 119.

FIG. 1G illustrates a schematic of a metasurface unit cell. The metasurface can be formed by periodically repeating the metasurface unit cells. The unit cell 160 comprises a high-refractive index LGMR structure 162 on a low-refractive index electro-optic substrate 164. The LGMR structure 162 comprises asymmetrical protrusions 166. The asymmetric protrusions 166 are on the top surface of the LGMR structure 162. Bragg gratings 165 are overlaid on top of the asymmetrical protrusions 166 such that the Bragg gratings 165 are also asymmetrical. The unit cell comprises two electrically conductive electrodes 168. Each of the two electrodes 168 is positioned on a side of the LGMR structure 162 such that a DC electric field can be applied in the x-direction to modulate the refractive index of the electro-optic substrate 164. The two electrodes 168 are biased with respect to each other. Although the LGMR structure 162 is on an electro-optic substrate 164 as shown in FIG. 1G, the LGMR structure 162 can also be placed on a thin electro-optic layer 114 on a low-refractive index substrate 119.

FIG. 1H illustrates a schematic of a metasurface unit cell. The metasurface can be formed by periodically repeating the metasurface unit cells. The unit cell 170 comprises a high-refractive index LGMR structure 172 on a low-refractive index electro-optic substrate 174. The LGMR structure 172 comprises asymmetrical protrusions 176. The asymmetric protrusions 176 are on the top surface of the LGMR structure 172. Bragg gratings 175 are overlaid on top of the asymmetrical protrusions 176 such that the Bragg gratings 175 are also asymmetrical. The unit cell comprises three electrically conductive electrodes 178. A first and a second of the three electrodes 178 are positioned on each side of the LGMR structure 172, and the first and second electrodes are grounded. A third electrode 158 is positioned between the LGMR structure 172 and the electro-optic substrate 174. A DC electric field can be applied between the grounded electrodes and the third electrode. Although the LGMR structure 172 is on an electro-optic substrate 174 as shown in FIG. 1H, the LGMR structure 172 can also be placed on a thin electro-optic layer 114 on a low-refractive index substrate 119.

### Symmetry Breaking Transmissive Metasurfaces

Many embodiments provide picometer-scale spatial symmetry breaking in active transmissive metasurfaces. In several embodiments, transmissive electro-optic metasurface are described. The metasurface comprises an array of silicon waveguides with periodic protrusions, individually controlled at the 100 pm scale, supports well-defined high-Q (>2000) guided-mode resonances (GMRs). Interdigitated push-pull electrodes can be integrated between subwavelength-spaced GMR elements to locally tune the refractive index in the lithium niobate substrate, thereby shifting the GMR resonance and enabling opposite phase and amplitude modulation between neighboring radiative elements. In a geometrically symmetric metasurface, this effect introduces electro-optic beam splitting via diffraction, with diffraction efficiencies of about 3%. By introducing controlled passive resonance detuning via 100 pm scale protrusion shifts, the efficiency of amplitude modulation can be increased by six-fold through geometrical symmetry breaking, achieving amplitude modulation depths of about 40% at ±30 V. The high-Q GMR structures can achieve active and passive resonance control for electro-optic modulation or multifunctional sensing.

High-Q optical resonances in dielectric nanostructures can enable compact and efficient control of light-matter interactions even for materials with small refractive index contrast or modulation. GMRs supported by periodically structured waveguides enable high Q-factors, large phase dispersion, and enhanced field confinement within subwavelength-scale radiative elements with subwavelength periods. Many researchers have exploited these resonances in design of passive metasurfaces, and the strong sensitivity of resonances to element geometry leads to efficient beam shaping in transmission and reflection by controlling the phase and amplitude of the GMR elements. While efficient active control has been achieved by modulating optical resonances through thermo-optic or electro-optic effects in material systems, the geometrical definition of the resonant modes ultimately governs their linewidth, symmetry, and radiative coupling, and therefore the achievable tuning response. Many embodiments investigate the strong sensitivity of high-Q resonances to both material properties and element geometry to enhance the electro-optic response in a transmissive metasurface. The resonant elements can be formed by silicon waveguides with a well-defined protrusion period, patterned with 100 pm-scale precision on lithium niobate. The repeating unit of the silicon waveguide on lithium niobate is a unit cell of the metasurface. The electro-optic substrate serves as the active medium, whose refractive index is modulated under externally applied electric fields via the Pockels effect. By integrating interdigitated push-pull electrodes between neighboring GMR elements in the metasurface, periodic electro-optic detuning of the resonances can be achieved across the array. This controlled symmetry breaking enables voltage-tunable diffraction and beam control via simultaneous phase and amplitude modulation of subwavelength-spaced radiative GMR elements. Leveraging precise control of geometric design together with electro-optic tuning, compact active beam shaping in transmission can be achieved. The architecture supports cascaded optical systems, enabling integration with chip-scale light sources and detectors and allowing multiple functional layers to be stacked without obstructing the optical path.

In many embodiments, the active transmissive metasurface comprises an array of silicon waveguides (w×h=400 nm×240 nm) fabricated on a bulk lithium niobate substrate. Each waveguide incorporates periodic sidewall protrusions with dimensions of dₚ=50 nm and lₚ=80 nm, enabling the excitation of guided-mode resonances with the Quality factor Q=λ/Δλ at the free-space wavelength λ. The periodic protrusions provide the necessary momentum to couple light from free space into the waveguides, enabling the excitation of the resonant mode inside the waveguide. The periodicity of the protrusion determines the spectral position of the guided mode resonance, according to the phase matching condition k₀ sin θ+mG=k₀ n_{eff} with the free-space wave vector k₀, the angle of incidence θ, the diffraction order m, the grating vector G=2π/∧ with period ∧ and the mode effective index n_{eff} of the guided mode. Driving electrodes are integrated to modulate the refractive index of the substrate by applying an electric field. A change in the refractive index modifies the mode effective index n_{eff} which in turn spectrally shifts the guided-mode resonance. This shift is reflected in both the spectral position of the transmission dip and in the corresponding phase response of light passing through the metasurface under normal incidence (θ=0°). A phase shift as high as 200 degrees can be achieved by applying a voltage of 30 V.

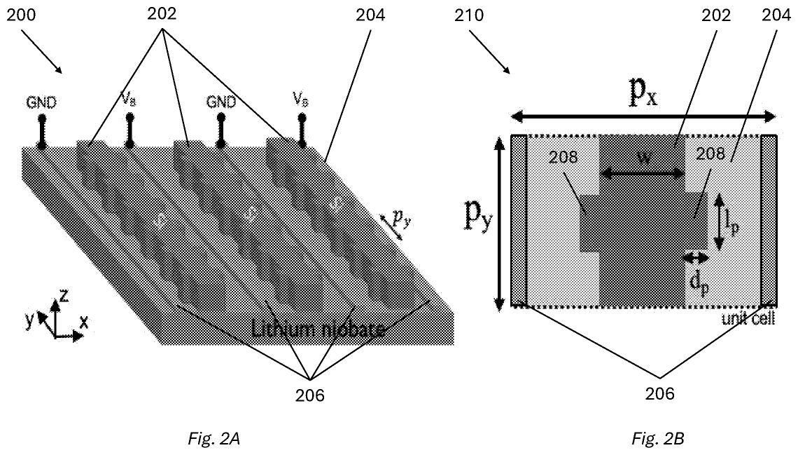

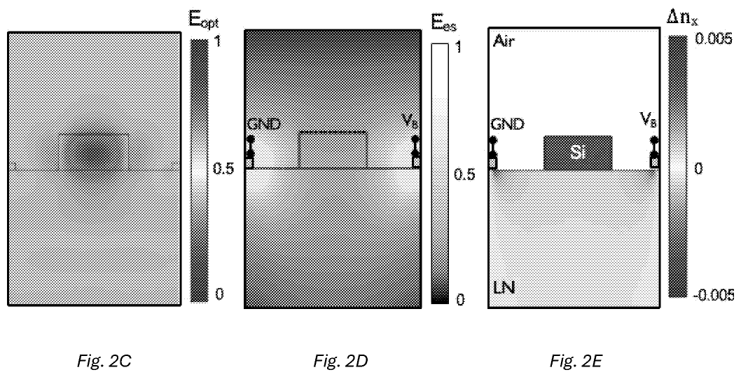

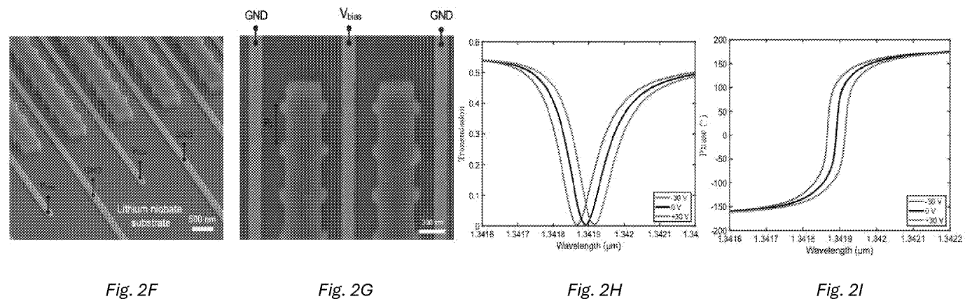

FIG. 2A illustrates a schematic of a silicon lithium niobate transmissive metasurface in accordance with an embodiment. The metasurface 200 comprises periodically perturbed silicon waveguides 202 (supporting GMRs) on a lithium niobate (LN) substrate 204. Electrodes 206 can be integrated into the metasurface 200 to apply a DC electric field to modulate the refractive index of the LN substrate 204. The electrodes 206 can be interdigitated electrodes. The electrodes 206 can be arranged in an alternating ground (GND) and bias (V_{B}) pattern to have the push and pull effect.

FIG. 2B illustrates a top view of a unit cell of the silicon lithium niobate transmissive metasurface in accordance with an embodiment. The unit cell 210 can be repeated periodically in two dimensions or three dimensions to form the transmissive metasurface. The unit cell 210 can have a periodicity on the x-direction pₓ and a periodicity on the y-direction p_{y}. The unit cell 210 comprises a silicon waveguide (or silicon GMR) 202 on a LN substrate 204 and two electrodes 206. The silicon waveguide 202 comprises two symmetrical protrusions 208 protruding from the sides of the silicon waveguide 202. The silicon waveguide 202 can have a width w that does not include the protrusions 208. The protrusions 208 can each have a length in the y-direction lₚ and a depth in the x-direction dₚ.

FIG. 2C illustrates a simulated optical field Eₒₚₜ profile of the guided mode confined in a single perturbed waveguide, showing strong vertical confinement. FIG. 2C shows the optical field of the unit cell. FIG. 2D illustrates a simulated electrostatic field under applied voltage. FIG. 2D shows the electric field of the unit cell. FIG. 2E illustrates a resulting refractive index modulation Δnₓ in the lithium niobate induced by the applied voltage via the Pockels effect. FIG. 2E shows the refractive index modulation of the unit cell. FIG. 2F illustrates a tilted-view scanning electron microscope (SEM) image of the fabricated GMR metasurface. FIG. 2G illustrates an SEM image of two adjacent GMR resonator elements with a single driving electrode positioned between them. FIG. 2H illustrates guided-mode resonance in the transmission spectrum at 0 V and under applied bias of ±30 V. FIG. 2I illustrates phase response extracted from simulations at 0 V and under applied bias ±30 V, revealing electro-optic tunability of the transmitted phase.

The device can be fabricated using lithographic nanofabrication processes. A 240-nm-thick amorphous silicon film is structured on a bulk x-cut lithium niobate substrate. Arrays of 150 μm×150 μm silicon GMR elements with a well-defined protrusion period can be fabricated to allow deterministic tuning of the spectral position of the guided-mode resonance. Interdigitated electrodes can be integrated adjacent to the waveguides to enable push-pull electro-optic tuning.

The metasurface can be oriented such that the electrodes are aligned perpendicular to the optical axis of the lithium niobate crystal, thereby maximizing the overlap with its largest Pockels coefficient. r33=32 pm/V. Precise alignment between the lithographic steps is required to ensure that the electrodes (width×height=90 nm×50 nm) are positioned centrally between the silicon GMR elements, minimizing the impact of optical loss from the metallic electrodes on the guided-mode resonance.

To experimentally characterize the metasurface, the device is illuminated with linearly polarized light at normal incidence through the substrate, using a supercontinuum light source or a wavelength-tunable diode laser. The transmitted light is collected with an objective lens and routed either to an InGaAs infrared camera for imaging or focused onto a photodetector for electro-optic characterization. A pronounced dip in the transmission spectrum appears at resonance, exhibiting a minimum full width at half maximum (FWHM) linewidth of 0.5 nm. The minimum transmission at resonance ranges between 20-40%. Fitting the spectral response with a Lorentzian lineshape function reveals GMR Q-factors with values of about 3000. As the protrusion period decreases, the resonance dip shifts toward shorter wavelengths, in agreement with the expected phase-matching condition of a guided-mode resonance. The electro-optic modulation in a metasurface structure with a uniform protrusion period of p_{y}=490 nm exhibits a guided-mode resonance at 1283 nm with a measured Q-factor of 2400. Since the GMR condition depends on the effective refractive index of the silicon waveguides, even small fabrication-induced variations in the silicon refractive index or waveguide geometry can result in pronounced shifts of the resonance wavelength. This sensitivity explains the observed deviation of the GMR spectral position from simulations based on the nominal geometry and literature values of the optical constants. To account for fabrication uncertainties, the waveguide geometry and the optical constants of silicon can be defined in the model within realistic tolerance ranges, based on SEM and AFM characterization of the fabricated devices, to achieve agreement with the experimentally observed spectral position of the GMR resonance. While the measured quality factor is high (Qₑₓₚ=2400), it is lower than the simulated value (Qₛᵢₘ=8350) due to the idealized lossless material properties and perfectly periodic and infinite geometry assumed in the simulations. To account for material absorption, a finite optical loss k_{Si} can be set as 0.0001, which contributes to the intrinsic damping of the resonant mode and leads to a reduced simulated quality factor in closer agreement with experiment. The adjusted parameters are retained for subsequent simulations and analysis.

When a bias is applied across the interdigitated push-pull electrodes, the electric field direction alternates beneath adjacent GMR elements. Owing to the linear electro-optic effect in lithium niobate, this produces refractive-index changes of opposite sign via the r₃₃ tensor component, resulting in opposite resonance shifts between neighboring resonator elements. These shifts introduce phase modulation while leaving the radiative coupling strength and spectral resonance linewidth unchanged. From the expansion of the transmission, T(λ±Δλ)≈T(λ)±ΔλδλT(λ), the opposite resonance shifts lead to a cancellation of the linear terms, such that the total transmitted amplitude remains constant to first order. Consequently, the resulting electro-optic modulation introduces phase modulation with only small global amplitude variation. The metasurface is designed with subwavelength spacing between adjacent GMR elements and therefore supports only the zeroth diffraction order under zero bias, in the absence of any electro-optically induced symmetry breaking between elements. Under push-pull electro-optic tuning, antisymmetric phase modulation across a two-element unit cell forms a dynamic grating with an effective period larger than the operating wavelength, thereby introducing electro-optically controlled diffraction orders under applied bias.

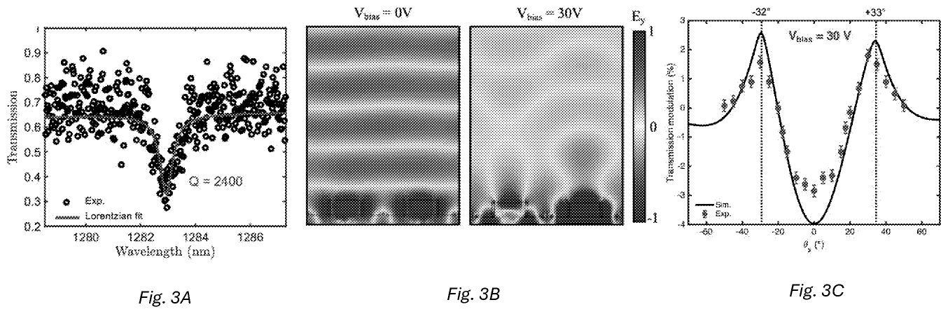

The subwavelength radiative elements experience both phase and amplitude modulation, which together determine the diffraction efficiency of the electro-optic grating. Maximum diffraction efficiency is achieved for local phase-only radiative elements. However, as shown in FIG. 2H and FIG. 3A, the transmission within each radiative element varies strongly around the guided-mode resonance, with the transmission minimum at the resonance wavelength. Consequently, the electro-optic modulation intrinsically couples local phase and amplitude variations, leading to deviations from the ideal phase-only diffraction. Although the phase response is strongest at the guided-mode resonance, the simulated local transmission minimizes at this spectral position. Optimal device operation therefore occurs on resonance, where a phase modulation is maintained while sufficient transmission is enabled by a symmetric shift of the transmission. The expected diffraction efficiencies can be estimated from the voltage-dependent amplitude and phase profiles obtained by FEM simulations. A near-field to far-field transformation is applied to compute the diffracted power distribution. The transmitted power at the respective wavelength is used for normalization of the electro-optic (EO) diffraction efficiencies. The diffraction angles are determined by the electro-optically induced grating period, d_{EO}=2d. With the nominal separation d=1200 nm of GMR elements, the push-pull modulation creates an effective supercell of d_{EO}=2400 nm that sets the diffraction angle to θₓ=±(32±1°). Using Fourier-plane imaging of the transmitted field, the modulation depth can be quantified in momentum space and electro-optic diffraction can be observed at an operating wavelength of 1283.1 nm. The maximum diffraction efficiency is (3.2±0.5)%. The experimentally measured diffraction efficiencies agree with the simulated values, with minor deviations attributable to fabrication tolerances and material losses.

FIG. 3A through FIG. 3C illustrate symmetric guided-mode-resonance metasurface enabling electro-optic beam splitting via dynamic diffraction in accordance embodiments. FIG. 3A illustrates a transmission spectrum showing the guided-mode resonance at λ=1283 nm with a quality factor of Q=2400. FIG. 3B illustrates simulated near-field distribution of the out-of-plane electric field component Ey under zero bias (left) and an applied bias of 30 V (right), illustrating the emergence of spatially periodic radiation under electro-optic actuation. FIG. 3C illustrates measured modulation depth as a function of in-plane wavevector kₓ, demonstrating voltage-controlled redistribution of optical power into the first diffraction order.

To enable efficient electro-optic amplitude modulation in transmission, many embodiments provide metasurfaces where neighboring GMR elements are passively detuned. This can be achieved by introducing a slight offset in the protrusion period p_{y} between every second GMR element. In some other embodiments, the offset can be achieved by changing at least one of: the height of the metasurface unit cells, the width of the metasurface unit cells, and/or the geometric dimensions of the protrusions. As a result, the unit cell comprises two structurally distinct radiative elements that exhibit individually different resonance wavelengths. Notably, this detuning is introduced structurally through sub-nanometer variations in the protrusion period. The GMR response is governed by the collective lattice resonance of an extended array of unit cells (~300 elements spanning the 150-μm-long metasurface), such that the effective detuning is defined by the ensemble response of the entire resonator array. Consequently, the effective resonance condition reflects an ensemble-averaged structural protrusion that is statistically well defined over hundreds of elements, enabling reproducible and robust sub-nm protrusion shifts despite the finite accuracy of the used nanofabrication processes. The resonance shifts can be as small as 0.45 nm, arising from a Δp_{y}=400 pm variation in the protrusion period of the metasurface. This shift is slightly smaller than predicted by simulations, which can be attributed to the extreme sensitivity of the resonance to nanometer-scale geometric variations and uncertainties in the optical properties of the metasurface materials.

When an electrostatic field is applied using the push-pull electrodes, the resonance wavelengths of the two detuned elements shift in opposite directions, producing a strong modulation of the transmitted amplitude at an intermediate wavelength between the two overlapping GMR resonances. Unlike the symmetric unit cell, in which antisymmetric resonance shifts predominantly induce phase modulation while preserving the overall transmission, the intentional detuning breaks this cancellation when the device is operated at a wavelength positioned between the slightly overlapping resonances. Consequently, the opposite spectral shifts translate into an asymmetric transmission response within the two-element unit cell, resulting in an enhanced amplitude modulation of the transmitted field, with a maximum transmission modulation of 40% achieved at a driving voltage of 30 V_{AC} in the 400 pm-detuned metasurface. For the experimentally observed GMR with Q=1300, the optimum detuning of Δp_{y}=400 pm results in a six-fold enhancement of the amplitude modulation efficiency. Notably, the modulation depth can be further increased by exploiting higher-Q resonances through reduced scattering and optical losses in the metasurface. Although the absolute operating wavelength may drift due to temperature fluctuations or mechanical deformation, both resonances are expected to shift synchronously, thereby preserving their relative detuning. As a result, global wavelength drifts shift both resonances together without altering their separation, preserving the operating point between them and ensuring inherent robustness against spectral fluctuations. This characteristic makes the passively detuned metasurface attractive for ultrasensitive sensing applications, as well as for stable electro-optic amplitude modulation in environments subject to thermal or refractive-index fluctuations, or in systems where the operating wavelength is intentionally tuned, such as thermally controlled distributed-feedback (DFB) lasers. Due to the inherent nature of active transmissive metasurfaces, cascaded operation and inherent integration with chip-scale lasers are straightforward, enabling compact and scalable photonic system architectures.

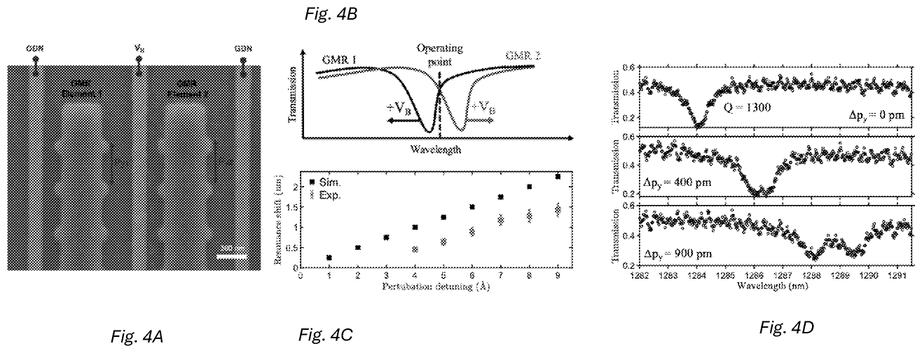

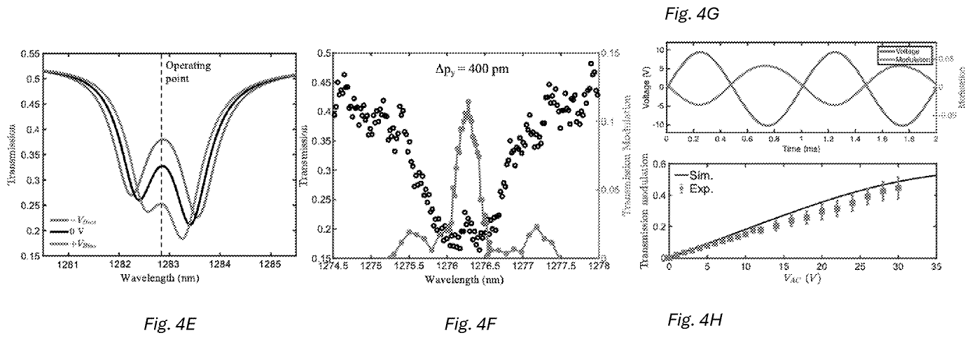

FIG. 4A through FIG. 4H illustrate detuned GMR metasurface for efficient transmission modulation in accordance with embodiments. FIG. 4A illustrates an SEM image of two neighboring GMR elements with slightly different protrusion periods p_{y1} and p_{y2}, forming a detuned two-element unit cell with interdigitated push-pull electrodes. FIG. 4B illustrates a schematic of two spectrally detuned GMRs and the operating point between them, where opposite electro-optic resonance shifts under applied bias lead to asymmetric transmission modulation. FIG. 4C illustrates simulated and experimental resonance shift as a function of the protrusion-period offset. FIG. 4D illustrates spectral response of metasurfaces with geometrical detuning parameters Δp_{y}=0 pm, Δp_{y}=400 pm, and Δp_{y}=900 pm. FIG. 4E illustrates simulated transmission spectrum of the detuned GMR metasurface under an applied bias of V_{bias}=±15 V, demonstrating pronounced amplitude modulation between the guided-mode resonances. An optical loss of k_{Si}=0.0005 is introduced for silicon to obtain a resonance quality factor of Q=1300, matching the experimentally ob-served value. FIG. 4F illustrates transmission modulation spectrum for Δp_{y}=0.4 at a driving voltage of V_{AC}=10 V. FIG. 4G illustrates time-domain measurement of electrical drive voltage and resulting optical transmission modulation, confirming linear electro-optic response at the operation point. FIG. 4H illustrates modulation depth as a function of the driving voltage V_{AC}.

Many embodiments provide active transmissive metasurface based on high-Q guided-mode resonances in silicon-on-lithium niobate that enables electrically controlled phase and amplitude modulation through symmetry tuning. Interdigitated push-pull electrodes induce opposite electro-optic resonance shifts in neighboring GMR elements, resulting in electro-optic diffraction in geometrically symmetric metasurfaces. Introducing 100 pm scale passive detuning between adjacent elements intentionally breaks this cancellation, converting antisymmetric resonance shifts enabling a sixfold increase in transmission amplitude modulation efficiency. As the response arises from the collective behavior of a large ensemble of unit cells, the modulation exhibits intrinsic tolerance to fabrication variations and thermal drift. These results establish a general strategy for combining passive resonance control with active electro-optic tuning in transmissive metasurfaces, enabling compact, cascaded photonic platforms for dynamic beam shaping, modulation, and sensing.

### EXEMPLARY EMBODIMENTS

Although specific embodiments of systems and apparatuses are discussed in the following sections, it will be understood that these embodiments are provided as exemplary and are not intended to be limiting.

### Example 1: Numerical Modeling

Finite element method (FEM) simulations are performed using commercially available software. For the electrostatic simulations, the device unit cell is modeled with the unclamped static relative permittivity tensor of LN (ϵₓₓ=ϵ_{yy}=27.8, ϵ_{zz}=84.5), while the relative permittivity of air is set to be ϵₐᵢᵣ=1, and the boundaries of the two gold nanostrips are set to ground and V_{bias} potential, respectively. The calculated electric-field distribution is utilized to determine the modification of the refractive index in the LN substrate by using the electro-optic Pockels coefficients (restricting to the largest diagonal terms, i.e., Δnᵢᵢ=−0.5r_{iiz}nᵢᵢ₃Eₓ, with r_{yyx}=r_{zzx}=10.12 pm/V and rₓₓₓ=31.45 pm/V), which are considered to be non-dispersive over the investigated wavelength range. For the electro-optical simulation, the modified distribution of the refractive index of LN is fed into the 3D full-wave simulation, while the unmodified refractive indices from Au and LN (nₓₓ=n_{yy}=nₒ=2.221, n_{zz}=nₑ=2.146 at λ₀=1280 nm). Excitation and detection ports in combination with periodic boundary conditions at the sidewalls of the unit cell are applied to calculate the transmission and phase as a function of the applied voltage, which is used for investigating the shift of the GMR and the corresponding transmission and phase response.

### Example 2: Device Fabrication

Devices are fabricated on commercially available x-cut lithium niobate substrates with gold alignment markers, which are defined in a prior step using electron beam lithography, metal deposition, and lift-off. The silicon waveguide array metasurfaces are patterned by electron beam lithography in a spin-coated 200-nm-thick PMMA A4 positive resist. The electron-beam exposure uses a minimum beam step size of 0.1 nm. After development, a 15 nm layer of Al₂O₃ is deposited to serve as an etch hard mask, followed by lift-off. A SF₆/C₄F₈ etch chemistry is used to transfer the pattern into the silicon over a 2-minute etch. The gold alignment markers are used for lithographic overlay in the subsequent electron beam lithography step, where the electrodes (metasurface driving electrodes and macroscopic bonding pads) are defined. The chip is wire-bonded onto a printed circuit board (PCB), enabling electrical interfacing with external driving.

### Example 3: Electro-optic Characterization

The metasurfaces are characterized using a home-built optical transmission microscope. Coherent light from a wavelength-tunable diode laser or a broadband light source is loosely focused on the metasurface. The transmitted light is collected with an objective lens and projected either onto an InGaAs IR camera or a power meter. For power normalization, the sample is removed, and the illuminated power is measured through the same area. For the beam deflection measurements, a 0.9 NA objective is used to image the Fourier plane onto the camera.

### Example 4: Effect of Electrode Offset on Resonance Linewidth and Quality Factor

To estimate the impact of electrode misalignment on the optical resonance quality factor, electromagnetic simulations of the transmission spectrum can be performed for different lateral electrode offsets. The calculated transmission spectra for electrode offsets of 0 nm, 150 nm, and 200 nm, revealing a progressive broadening and shallowing of the resonance dip as the offset increases. With the 100 nm wide electrode positioned centrally between two GMR elements, the resonance exhibits a narrow linewidth and deep extinction, corresponding to a high intrinsic quality factor (Q>10000). As the electrode is displaced laterally closer to the optically confined mode in the Si ridge, scattering and radiation losses are introduced, leading to a reduced resonance contrast and an increased linewidth. The effect becomes increasingly pronounced for electrode offsets beyond ~100 nm.

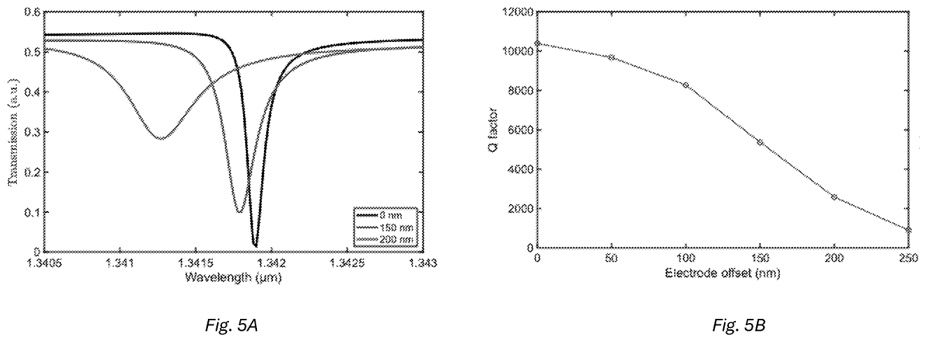

FIG. 5A and FIG. 5B illustrate effect of electrode offset on resonance linewidth and quality factor. FIG. 5A illustrates simulated transmission spectra for electrode offsets of 0 nm, 150 nm, and 200 nm, showing progressive resonance broadening, blueshift of the resonance and reduced extinction with increasing offset. FIG. 5B illustrates extracted quality factor as a function of electrode offset, showing a continuously reduced Q due to increased radiative and scattering losses.

### Example 5: Spectral GMR Shift Induced by Variation of the Protrusion Period

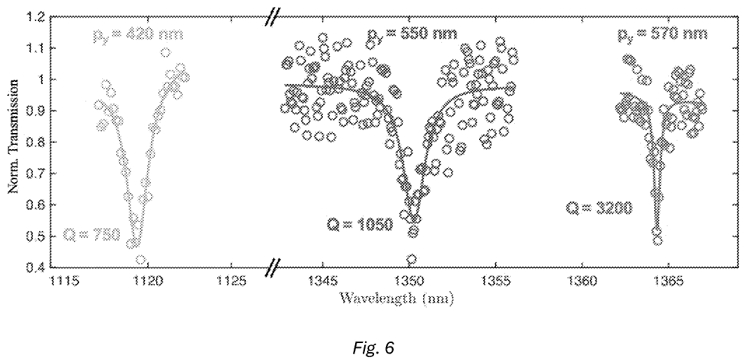

Many embodiments provide the dependence of the GMR spectral position on the protrusion period p_{y} of the metasurface. FIG. 6 summarizes the measured normalized transmission spectra for devices fabricated with three different protrusion periods, p_{y}=420 nm, 550 nm, and 570 nm. A redshift of the resonance wavelength is observed as the protrusion period is increased. Specifically, the resonance shifts from ~1120 nm for p_{y}=420 nm to ~1350 nm for p_{y}=550 nm, and further to ~1365 nm for p_{y}=570 nm. This behavior is consistent with the phase-matching condition of guided-mode resonances, where the in-plane momentum provided by the protrusion determines the coupling between free-space radiation and the guided mode. In addition to the spectral shift, we observe a pronounced increase in the resonance quality factor with increasing p_{y}. The extracted quality factors increase from Q≈750 for p_{y}=420 nm, to Q≈1050 for p_{y}=550 nm, and up to Q≈3200 for p_{y}=570 nm. This trend indicates a reduction in radiative coupling strength as the protrusion period approaches the weak-coupling regime. At shorter wavelengths, increased absorption in silicon contributes additional non-radiative loss, leading to broader resonances and reduced quality factors.

Notably, the observed spectral tuning is achieved without altering the underlying waveguide geometry or material composition, demonstrating that the protrusion period serves as an efficient and independent design parameter for setting the operating wavelength of the GMR. This degree of spectral tunability is particularly advantageous for multi-resonant and spatially multiplexed metasurface architectures.

FIG. 6 illustrates experimental transmission spectra of guided-mode resonances for different protrusion periods. Normalized transmission spectra measured for metasurfaces with protrusion period p_{y}=420 nm, p_{y}=550 nm and p_{y}=570 nm. Open circles denote experimental data, while solid lines represent Lorentzian fits to extract the resonance wavelength and quality factor Q.

### Example 6: Spectral GMR Shift Induced by Variation of the Optical Constants and Metasurface Geometry

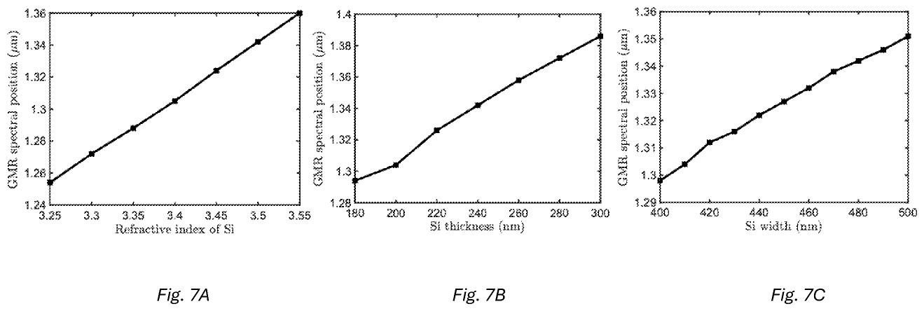

To assess the sensitivity of the guided-mode resonance (GMR) wavelength to realistic uncertainties in material parameters and device geometry, a series of parametric simulations are performed in which the refractive index of silicon, the silicon waveguide thickness, and the waveguide width are varied independently around their nominal values. These parameters are known to be subject to fabrication- and processing-induced variations, as well as uncertainty in literature optical constants. The spectral position of the GMR depends approximately linearly on the effective index of the silicon waveguides which is function of the refractive index of Si, and the waveguide geometry (FIG. 7A through FIG. 7C: in all three plots only a single parameter is varied while all other structural and material parameters are held fixed at their nominal values.). Considering typical fabrication tolerances for silicon waveguides and reported variations in the refractive index of deposited or etched silicon, the extracted dependences imply GMR wavelength shifts on the order of several tens of nanometers which is comparable to the experimentally observed deviation between the measured resonance position and simulations based on the nominal geometry and literature optical constants.

FIG. 7A through FIG. 7C illustrate sensitivity of the GMR spectral position to variations in silicon optical constants and waveguide geometry. FIG. 7A illustrates simulated shift of the GMR wavelength as a function of the refractive index of silicon. FIG. 7B illustrates dependence of the GMR spectral position on the silicon waveguide thickness. FIG. 7C illustrates dependence of the GMR spectral position on the silicon waveguide width.

### Example 7: Calibration of Silicon Refractive Index and Waveguide Geometry

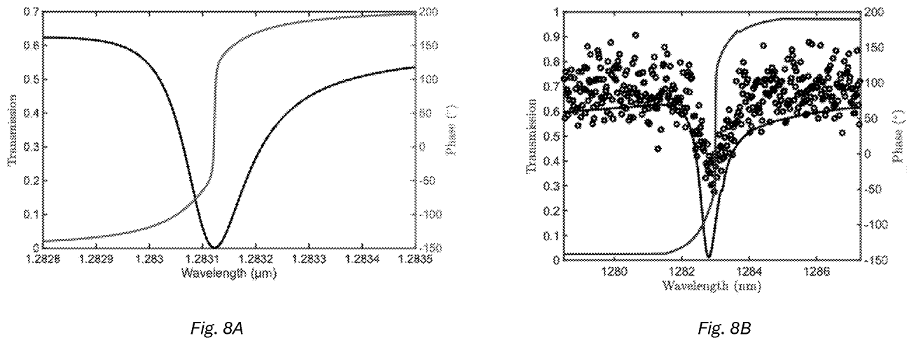

To establish an accurate reference for subsequent electro-optic modulation analysis, the silicon waveguide geometry and refractive index are refined by aligning the simulated guided-mode resonance with the experimentally observed resonance of the fabricated device. The structural parameters were independently extracted from SEM and AFM measurements. FIG. 8A presents the resulting simulated transmission spectrum (black curve) together with the corresponding phase response (orange curve) of the fabricated geometry, which assumes a silicon waveguide width of w_{Si}=475 nm, a waveguide thickness of t_{Si}=227 nm, and a complex refractive index of n_{Si}=3.37 and k_{Si}=0.0001.

FIG. 8A and FIG. 8B illustrate simulated transmission amplitude (black) and phase response (orange) of the calibrated silicon GMR structure. FIG. 8A illustrates transmission and phase of the GMR with lossless silicon. FIG. 8B illustrates transmission and phase of the GMR including silicon with k_{Si}=0.0001.

### Example 8: Modulation Enhancement in Detuned GMR Resonators

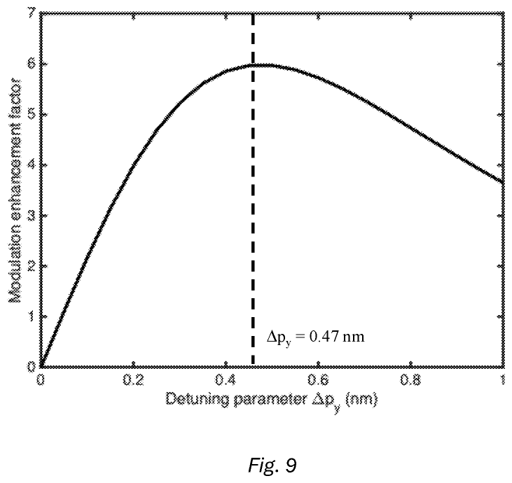

Using the experimentally measured transmission spectrum of the single-resonance GMR device (Q=1300), the response of the detuned metasurface can be numerically calculated by combining two spectrally shifted GMR resonances and evaluating the transmission modulation at a fixed operating wavelength located between the spectral positions of the two resonances. The electro-optic tuning efficiency of the GMR shift used in the calculation is 3.3 pm V⁻¹, obtained from multiphysics simulations performed in COMSOL. FIG. 9 shows the resulting modulation enhancement for a bias voltage of V_{bias}=±10 V as a function of the static detuning parameter Δp_{y}, defined as the periodicity shift introduced in every second GMR element of the metasurface. The modulation enhancement increases with increasing detuning and reaches a maximum of approximately six times the modulation depth of a single-resonance GMR when the detuning becomes comparable to the resonance linewidth. For larger detuning values, the two resonances become increasingly separated and no longer overlap in the spectral region of highest slope of the individual resonances. As a result, the combined response decreases and the modulation enhancement correspondingly drops.

FIG. 9 illustrates calculated modulation enhancement of a detuned GMR metasurface at a driving voltage of V_{bias}=10V as a function of the static detuning parameter Δp_{y}. The modulation enhancement reaches a maximum of approximately six compared to a single resonance when the detuning becomes comparable to the resonance linewidth. The dashed red line indicates the experimentally implemented detuning parameter Δp_{y}=0.47 nm.

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a”, “an”, and “the” may include plural referents unless the context clearly dictates otherwise. Reference to an object in the singular is not intended to mean “one and only one” unless explicitly so stated, but rather “one or more”.

As used herein, the terms “approximately”, and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to +0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A metasurface, comprising:
a plurality of unit cells;
wherein each of the plurality of unit cells comprises:
a resonant structure, wherein the resonant structure comprises two protrusions, wherein the two protrusions are configured to couple light from free space into the resonant structure such that an excitation of a resonant mode occurs inside the resonant structure;
an electro-optic layer, wherein the resonant structure is on the electro-optic layer, wherein the resonant structure has a higher refractive index than the electro-optic layer;
a first electrode connected to a ground, wherein the first electrode is adjacent to a first side of the resonant structure, wherein the first electrode is on the electro-optic layer; and
a second electrode connected to a voltage, wherein the second electrode is adjacent to a second side of the resonant structure, wherein the second side is on an opposite side of the first side, wherein the second electrode is on the electro-optic layer;
wherein the first electrode and the second electrode are configured to apply an electric field laterally across the electro-optic layer to change a refractive index of the electro-optic layer to modulate an optical response of the metasurface.

2. The metasurface of claim 1, further comprising a substrate, wherein the electro-optic layer is on the substrate.

3. The metasurface of claim 1, wherein the plurality of unit cells is arranged in an array.

4. The metasurface of claim 2, wherein the resonant structure has a higher refractive index than the substrate.

5. The metasurface of claim 1, wherein the electro-optic layer has a different refractive index than the substrate.

6. The metasurface of claim 1, wherein the resonant structure comprises a material selected from the group consisting of: silicon, amorphous silicon, germanium, gallium arsenide, gallium phosphide, titanium oxide, and molybdenum disulfide.

7. The metasurface of claim 1, wherein the electro-optic layer comprises a material selected from the group consisting of: barium titanate, lithium niobate, lead zirconate titanate, and JRD1.

8. The metasurface of claim 1, wherein the first electrode and the second electrode each comprises a material selected from the group consisting of: gold, silver, copper, palladium, platinum, indium tin oxide, cadmium oxide, gallium arsenide, indium arsenide, and molybdenum disulfide.

9. The metasurface of claim 1, wherein the resonant structure is symmetrical and each of the two protrusions protrudes from the first side and the second side respectively.

10. The metasurface of claim 1, wherein the resonant structure is asymmetrical and each of the two protrusions protrudes from the first side and the second side respectively.

11. The metasurface of claim 1, wherein the resonant structure is symmetrical and the two protrusions protrude from a top surface of the resonant structure.

12. The metasurface of claim 1, further comprising a Bragg grating, wherein the Bragg grating is on top of the two protrusions.

13. The metasurface of claim 1, further comprising a back reflector on an opposite side of the electro-optic layer from the resonant structure.

14. The metasurface of claim 1, wherein a repeating unit comprises two unit cells, wherein a first unit cell has a periodicity in y-direction different from the periodicity in y-direction of a second unit cell.

15. The metasurface of claim 14, wherein the difference of periodicity in y-direction is less than 500 picometers.

16. The metasurface of claim 1, further comprising a third electrode, wherein the third electrode is positioned between the resonant structure and the electro-optic layer.

17. The metasurface of claim 1, wherein the electro-optic layer comprises lithium niobate, wherein the first electrode and the second electrode are aligned perpendicular to an optical axis of lithium niobate to maximize an overlap with a Pockels coefficient.

18. The metasurface of claim 1, wherein the electric field direction alternates beneath adjacent resonant structures such that opposite resonance shifts occur between adjacent resonant structures.

19. The metasurface of claim 1, wherein the resonant structure comprises silicon and the electro-optic layer comprises lithium niobate.

20. The metasurface of claim 1, wherein the metasurface is configured to be a portion of: a wavefront shaping system, a dynamic beam steering system or a chip scale laser.
